(19) United States
(12) Patent Application Publication
(10) Pub. No.: US 2011/0187574 A1
(43) Pub. Date: Aug. 4, 2011

(54) REMOTE CONTROLLED POWER CONSUMING DEVICE AND MODULE

(75) Inventors: Andrew Charles Davison, Harrisburg, PA (US); John Eugene Westman, Harrisburg, PA (US); Steven Lee Flickinger, Hummelstown, PA (US); Boris Golubovic, San Francisco, CA (US); Mudhafar Hassan-Ali, Petaluma, CA (US)

(73) Assignee: TYCO ELECTRONICS CORPORATION, Berwyn, PA (US)

(21) Appl. No.: 12/846,245

(22) Filed: Jul. 29, 2010

Related U.S. Application Data
(63) Continuation-in-part of application No. 12/462,552, filed on Aug. 5, 2009.

(51) Int. Cl. H04L 17/02

(52) U.S. Cl. 341/176

(57) ABSTRACT

A power consuming device that includes a control circuitry controlling a plurality of components installed in the power consuming device comprises a communication module receiving communication signals from a remote source, and a control module including an electrical relay coupled between an external power source and the control circuitry, the control module coupled between the external power source and the communication module to provide power from the external power source to the communication module, and wherein the electrical relay is configured to transmit power from the power source to the control circuitry when the communication signals energize the electrical relay. A communication assembly utilized in a power consuming device is also described herein.

### CROSS REFERENCE TO RELATED APPLICATIONS

The present application is a continuation-in-part of, and claims priority from, commonly-owned U.S. application Ser. No. 12/462,552, filed Aug. 5, 2009 and entitled “Remote Controlled Power Consuming Device And Module Therefore”, the complete subject matter of which is expressly incorporated herein by reference in its entirety.

### BACKGROUND OF THE INVENTION

The subject matter disclosed herein relates generally to energy consuming devices, and more particularly, to an energy control system for an energy consuming device.

Many different types of energy consuming devices exist in the home, some of which are referred to as home appliances, which could include kitchen appliances such as refrigerators, stoves, dishwashers, freezers and the like. Other energy consuming home devices include items such as washers and dryers, hot water heaters, lighting, heating-ventilating-air-conditioning (HVAC) equipment, etc. At least some of these energy consuming devices have cycles which incur large electrical power usage yet could be completed at times discretionary to the homeowner. For example, refrigerators and freezers have automatically run defrost cycles, and many ovens have automatically operated oven cleaning cycles. In other instances, the cycle itself could be discretionary to the homeowner, for example the operation of washers/dryers and dishwashers could have delayed start features.

The reason that the start/run times for these appliances is relevant, is that the energy costs vary during the day due to the electrical demand or load. Electricity is sold in increments known as a kilowatt-hour (KW-hr). During peak electrical demand, the cost per KW-hr may be the highest. During reduced electrical demand, for example at nights/weekends, the cost per KW-hr may decrease, sometimes substantially, in the range of 20-50% less than on-peak costs. However, the consumer has no clear indication of when the on-peak/off-peak times are. Moreover, many consumers may not be aware of the difference in the cost between appliances operated during the peak electrical demand periods and the reduced electrical demand periods.

It would be advantageous if home appliances could “talk” to the utility companies and know when the on-peak/off-peak times are, such that discretionary functions could be operated during the off-peak times. This communication could be done wirelessly, or it could be done by communication into the device, for example over the power lines. This could be advantageous to both the consumer and the power company. The appliance/device communication could also be used so that the customer can access the controls of their appliance/device while not at home (i.e. changing the temperature on a thermostat remotely from a smart phone or other internet capable device).

In peak times, “brown-outs” or “black-outs” have occurred because of the overload on the power grids. If the power company had control back to the power consuming device, the company could back down or delay levels of power to certain functions remotely. Consumers eventually pay less, as utility companies can forego building further power generation plants.

Networks and/or their protocols exist, but not for the aforestated purpose. For example, one of the first wireless protocols for home automation was known as the X-10 protocol. Newer protocols include such wireless protocols as Zigbee™, Z-wave™ Bluetooth™ and/or Wi-Fi™. Signal over power networks include LonWorks available from Echelon Corporation at 550 Meridian Ave., San Jose, Calif. 95126.

### BRIEF DESCRIPTION OF THE INVENTION

In one embodiment, a power consuming device is provided. The power consuming device includes control circuitry for normal operation of components installed in the power consuming device. The power consuming device comprises a communication module, the communication module receiving communication signals from a remote source, and an electrical relay coupled between an external power source and the control circuitry. The electrical relay is also coupled between the external power source and the communication module, the electrical relay coupling power from the external power source to the communication module. The electrical relay is configured to transmit power from the external power source to the control circuitry when the communication module energizes the electrical relay based on the communication signals.

In another embodiment, a communication assembly utilized in a power consuming device is provided. The communication assembly interfaces with a public utility company and controls discretionary functions of a power consuming device having control circuitry controlling components installed in the power consuming device. The communication assembly includes a communication module, the communication module receiving communication signals from a public utility, and a control module comprising an electrical relay coupled between an external power source and the control circuitry. The control module also is coupled between the external power source and the communication module to provide power from the external power source to the communication module. The electrical relay is configured to transmit power from the external power source to the control circuitry when the communication module energizes the electrical relay based on the communication signals.

### BRIEF DESCRIPTION OF THE DRAWINGS

FIG. 1 is shows a diagrammatical depiction of a utility company and a wirelessly controlled energy consuming device.

FIG. 2 shows a perspective view of a communication assembly.

FIG. 3 shows the communication assembly of FIG. 2 as comprised of a communication module and a module interface.

FIG. 4 shows the outer housing of the communication module shown in FIG. 3.

FIG. 5 shows a top plan view of the outer housing shown in FIG. 4.

FIG. 6 shows a perspective view of the control board of a wireless module.

FIG. 7 shows an alternate diagrammatical depiction of a utility company and an energy consuming device which is controlled by signals transmitted over the power lines.

FIG. 8 shows a simplified schematic illustration of the exemplary communication assembly shown in FIGS. 1-7.

### DETAILED DESCRIPTION OF SPECIFIC EMBODIMENTS OF THE INVENTION

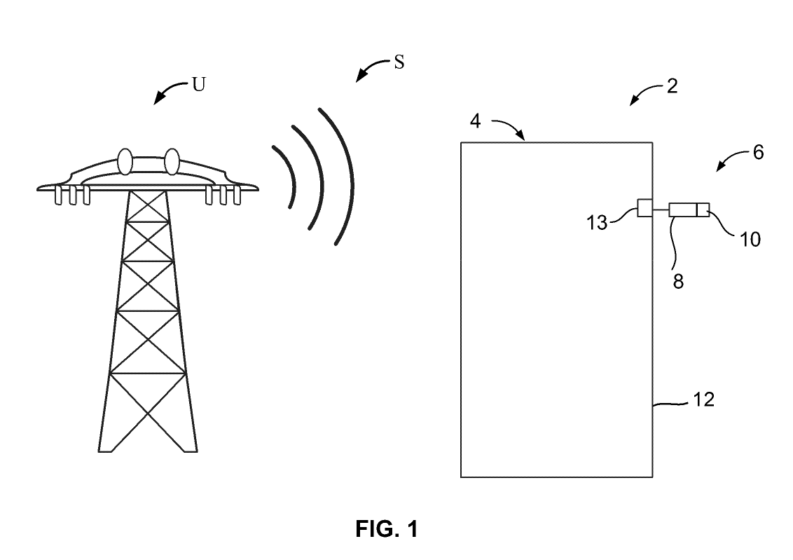

FIG. 1 illustrates a remotely controlled energy consuming device 2 that includes an enclosure 4. The enclosure 4 is configured to house the various components that represent the device 2, for example, the control circuitry, the motors, etc. In one embodiment, the device 2 is controlled wirelessly utilizing a communication assembly 6. Optionally, the device 2 may be controlled by signals over a power line. With respect first to FIG. 1, the wireless configuration will be described first.

The communication assembly 6 includes a module interface 8, a communication module 10, and a control module 13. The device 2 may be embodied as a home appliance, such as a refrigerator, a deep freezer, a washing machine, a dryer, a dishwasher, a microwave, and/or a hot water heater, for example. While the communication assembly 6 is shown in FIG. 1 diagrammatically, it should be realized that the communication assembly 6, or portions thereof, may be placed externally on the enclosure 4, where the module interface 8 is accessible, but not necessary visible to the eye. For example, on a refrigerator, the communication module 10 and the control module 13 may be mounted on an exterior portion of the back wall of the refrigerator. Optionally, the communication assembly 6, or portions thereof, may be mounted internally within the enclosure 4. For example, the communication module 10 may be mounted on an exterior portion of the refrigerator while the control module 13 is mounted on the interior portion of the refrigerator. In the exemplary embodiment, the module interface 8 is shown attached to a wall 12, which could be a structural wall of the home, or could be a wall of the device enclosure as discussed above.

As also shown in FIG. 1, a utility company is shown as “U” which sends signals “S” to be read by the communication assembly 6. While FIG. 1 shows the signals S being sent by the utility company U, it is contemplated that the signal emitter would be placed on or about the residence by the utility company U, for example at or in conjunction with the electrical meter, with the wireless signals being sent from a position proximate the residence.

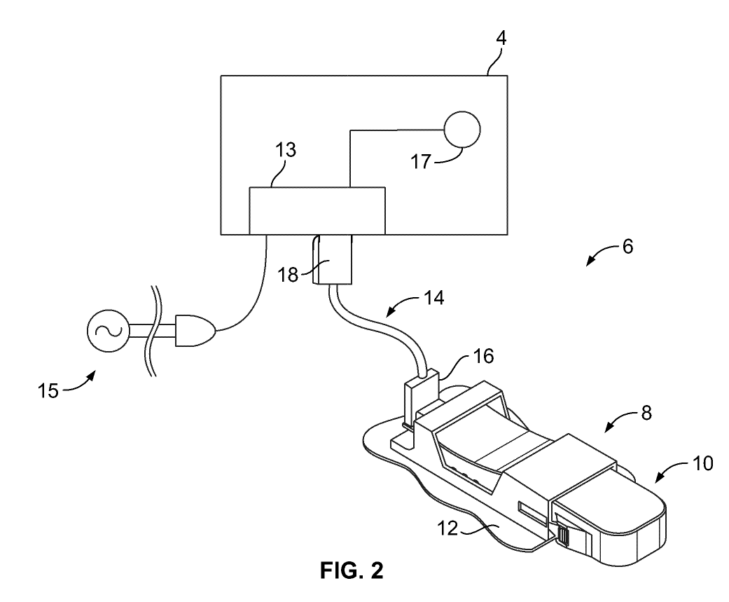

With reference now to FIG. 2, the communication assembly 6 includes the module interface 8 coupled to the wall 12, the communication module 10, and the control module 13. In the exemplary embodiment, the control module 13 is mounted to an interior portion of the device enclosure 4. Accordingly, the communication module 10 is coupled to the control module 13 via a wire harness 14. The wire harness 14 includes a first connector 16 connected to the wireless communication module 10, via the module interface 8, and a second connector 18 that is connected to the control module 13. Optionally, the communication module 10 may be directly attached to the control module 13, in which case the wire harness 14 is not utilized. In the exemplary embodiment, the control module 13 is configured to receive electrical power from an external source, such as an alternating current (AC) power source 15. The control module 13 is then configured to either transmit electrical power or prevent the transmission of electrical power, to various components installed in the energy consuming device 2, such as a motor 17, based on inputs received from the communication module 10. A more detailed description of the operational characteristics of the communication assembly 6 is discussed in more detail below.

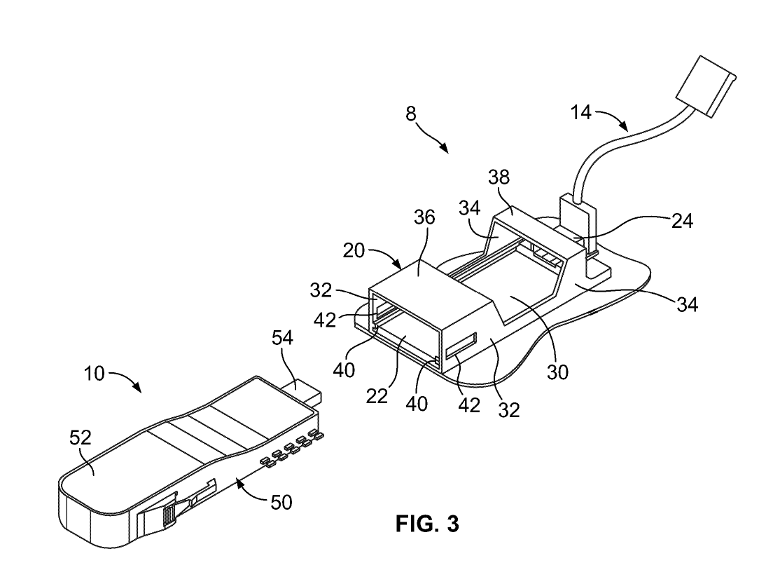

Referring to FIG. 3, the module interface 8 includes a receptacle housing 20 having an opening at 22, and a connector socket 24 positioned at an inner end of the receptacle housing 20. Connector socket 24 is then electrically connected to harness by a pin header, as is known in the art. Receptacle housing 20 includes a bottom mounting wall 30, sidewalls 32, 34, and top walls 36, 38. Side walls 32, 34 include alignment ribs 40 running along the length as described herein, and latch openings at 42.

The communication module 10 includes an outer housing 50 and a cover 52. The communication module 10 also includes an electrical connector 54 that is complementary with socket 24 for transmitting signals thereto. The assembly of the socket 24 and connector 54 may take any form of mating configuration, for example the configuration may be that of a universal serial bus (USB) or micro-USB profile, or any other mating configuration.

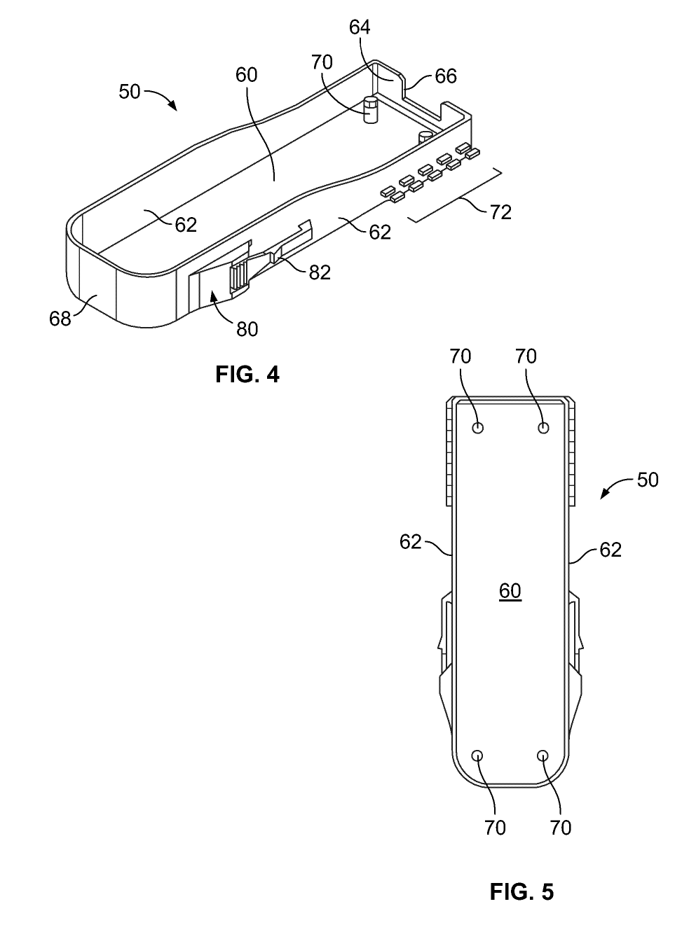

FIG. 4 is a perspective view of the housing 50 shown in FIG. 3. FIG. 5 is a side view of the housing 50. The housing 50 includes a pair of lower wall 60, a pair of sidewalls 62, an end wall 64 having opening 66, and an end wall 68. The lower wall 60 includes mounting posts 70 for mounting a communication board as further described herein. The sidewalls 62 include alignment members 72, shown here as two rows of staggered lugs, which receive ribs 40 (shown previously in FIG. 3) therebetween. The sidewalls 62 also include a plurality of latches 80 having a plurality of catches 82 which cooperate with openings 42 shown in FIG. 3.

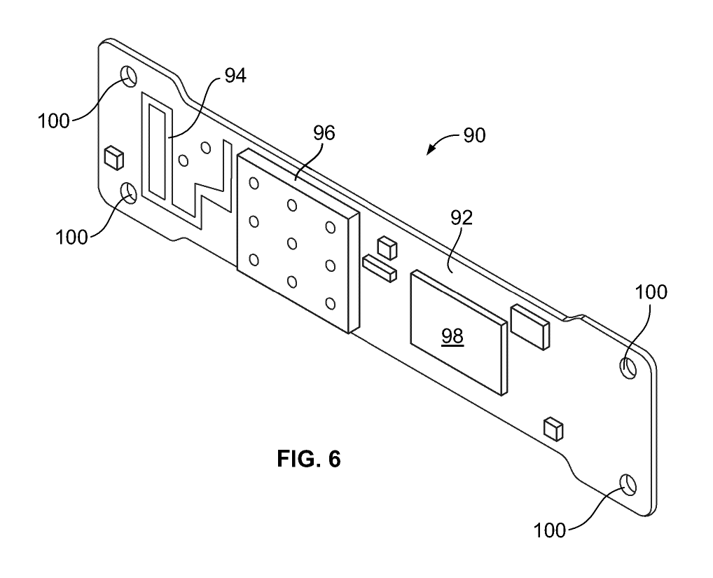

FIG. 6 is a perspective view of an exemplary communication board or card 90 which is configured to be received in housing 50. The communication board 90 includes a printed circuit board 92, an RF antenna 94, an RF chip 96, and a standardizing chip 98. The printed circuit board 92 includes apertures 100, in a like profile as the mounting posts 70. The mounting posts 70 may be threaded bosses which receive a threaded fastener for attaching the board 90, or may be heat-stake posts for attaching board 90.

As shown in FIG. 6, the antenna 94 is directly integrated with the board 92, for example as described in U.S. Pat. No. 6,087,972, the subject matter which is disclosed herein by reference. The antenna 94 may be in direct communication with chip 96. The chip 96 is referred herein as either an RF chip or as a protocol chip. The chip 96 may be specific to a wireless protocol language, for example Zigbee protocol. The protocol may be chosen by the utility company in the format in which it chooses to communicate. Chips specific to various protocols already exist; for example, chips in Zigbee™ protocol are available from Atmel Corporation of San Jose, Calif., or from Texas Instruments of Dallas, Tex.

In the exemplary embodiment, the chip 98 is referred to as a standardizing chip. During operation, the chip 98 functions to take the protocol of the chip 96 and standardize it to the control language of the specific device. Thus, multiple module combinations are contemplated as the protocol chosen by the utility company varies, as does the control language chosen by the specific device manufacturer. Thus, the standardizing chip 98 may be specific to the protocol and device control language, or the standardizing chip may be the same across all assemblies. The standardizing chip could be of the type available from Archtech Electronics Corp., of 117A Docks Corner Rd., Dayton, N.J. 08810.

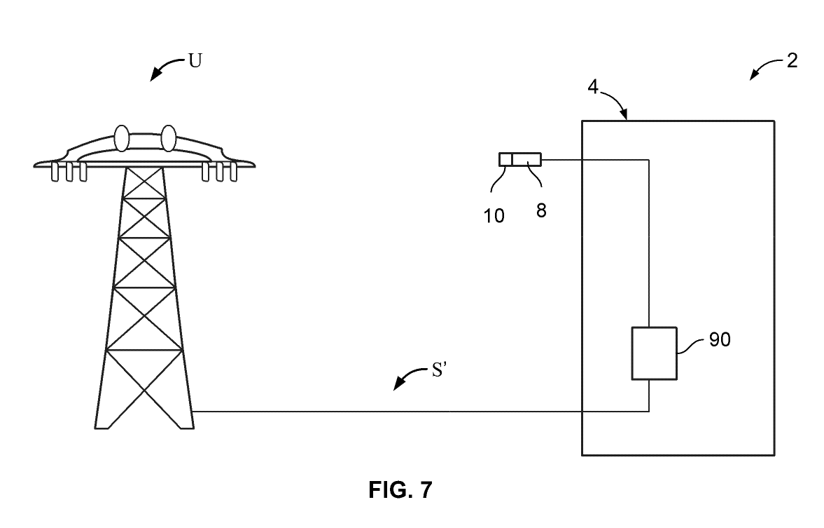

Alternatively and referring now to FIG. 7, the communication from the utility company U could be made by way of signals S′ directly over the power line. In this case the signals would be communicated directly to the communication board 90 and the communication signals would be received through the module interface 8 to the communication module 10, and then back to the control board through the standardizing chip 98 (shown previously in FIG. 6). In this case, the communication module 10 need not have the antenna, but may be included for redundancy, or for simplicity of manufacturing. The power company to device communication may be accomplished in at least 4 ways: Power Company to home=wired; Home to device=wired; Power Company to home=wired; Home to device=wireless; Power Company to home=wireless; Home to device=wired; and Power Company to home=wireless; Home to device=wireless.

Optionally, the antenna need not be part of the communication module 10. For example, in the event where the module interface 8 is embedded within the energy consuming device enclosure 4, the communication module 10 may be shielded from wireless signals. Thus an external antenna is also contemplated, where the antenna is mounted external to the device. Furthermore, in the event of a densely populated residential area, for example an apartment building, a single antenna may be provided for plural communication modules with encrypted signals. Furthermore, the signal over power lines does not have to go through the communication module 10, rather the signal may be transmitted directly to the electrical device utilizing the power transmitted throughout the house.

Thus, each energy consuming device manufacturer may include a module interface 8 having an industry standardized socket profile, for example USB or micro-USB. The modules 10 are then provided by the utility company, by the device manufacturer, or by a third party specifically designed to match the utility company protocol and the control language of the device manufacturer.

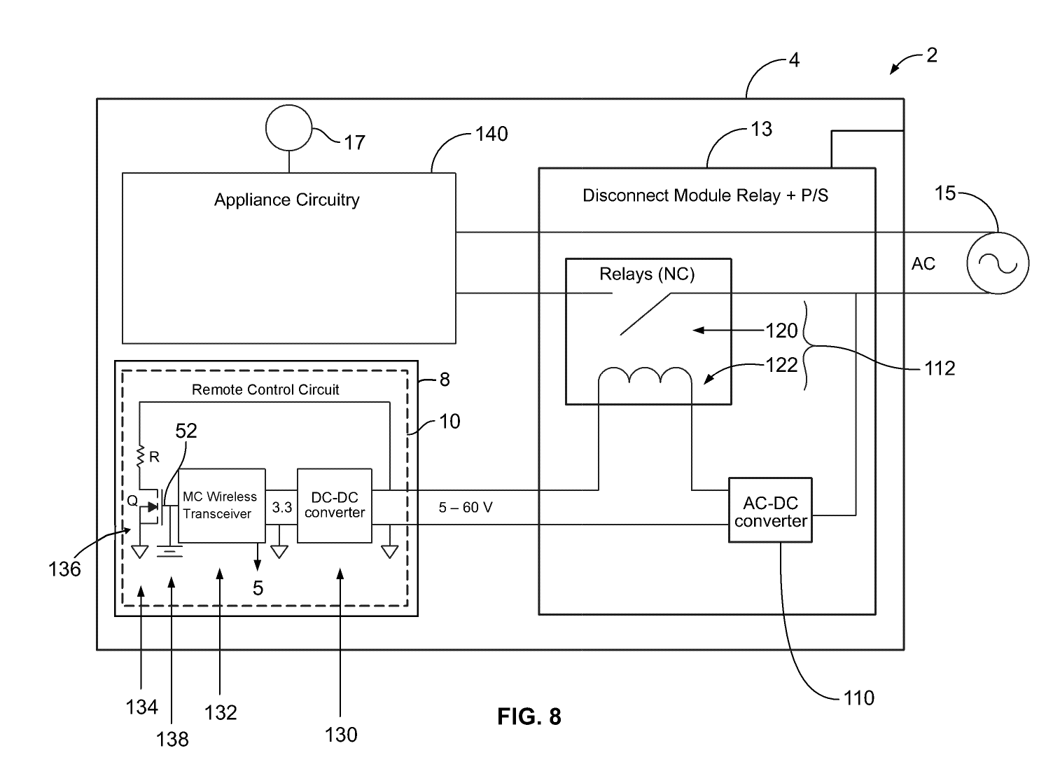

FIG. 8 is a simplified schematic illustration of the communication assembly 6 shown in FIGS. 1-7 installed in the exemplary energy consuming device 2, according to a specific embodiment. As discussed above, the communication assembly 6 includes the module interface 8, the communication module 10, and the control module 13. The communication assembly 6 may be operated either wirelessly or using a wired connection. In the exemplary embodiment, the communication assembly 6 is configured to enable a remote operator to control the operation of the energy consuming device 2. That is, according to the exemplary embodiment, module 10 provides control circuitry enabling remote control of the operation of appliance circuitry 140 that causes energy consuming device 2 to operate, and the module 10 is powered by external power source 15 via module 13. Moreover, the communication assembly 6 is configured to enable a local operator, such as the homeowner, to locally operate the energy consuming device 2 by overriding the operation of the communication assembly 6.

As shown in FIG. 8, the control module 13 includes an alternating current-to-direct current (AC-DC) converter 110 and an electrical relay 112. The relay 112 includes a switch 120 and a coil 122. During operation of the relay 112, the AC-DC converter 110 converts AC power received from the power source 15 to DC power. In the exemplary embodiment, the AC-DC converter 110 is a step-down converter that reduces the power received from the high voltage AC power source 15 to a lower voltage DC power level that is sufficient to reposition the switch 120. For example, in one embodiment, the AC-DC converter 110 reduces the voltage level from approximately 120 Volts AC to approximately 50 Volts DC. However, it should be realized that the AC-DC converter 110 is configured to reduce the voltage level to any voltage level required to reposition the switch 120, and that 50 Volts DC is exemplary only.

Moreover, during normal operation, power is also transmitted from the AC-DC converter 110 to the direct current-to-direct current (DC-DC) converter 130. In the exemplary embodiment, the DC-DC converter 130 is a step-down converter that reduces the power received from the AC-DC converter 110 to a low power level that is sufficient to operate the wireless transceiver 132. For example, in one embodiment, the DC-DC converter 130 reduces the voltage level from approximately 50 Volts DC to approximately 3.5 Volts DC. It should be realized that the wireless transceiver 132 is utilized to control the overall operation of the communication assembly 6. Therefore, the combination of the AC-DC converter 110 and the DC-DC converter 130 is configured to supply power to the wireless transceiver 132 under all operating conditions.

The relay 112 is configured to operate in two operational modes. In a first operational mode, DC power is transmitted through the coil 122 to generate an electromagnetic field in the coil 122. The electromagnetic field causes the switch 120 to move from a “closed” position, in which power is transmitted from the power source 15 to the appliance circuitry 140, to an “open” position in which power is not transmitted from the power source 15 to the circuitry 140. However, in a second operational mode, DC power is not transmitted through the coil 122. Accordingly, no electromagnetic field is generated. Thus, the switch 120 moves from the “open” position, in which power is not transmitted from the power source 15 to the circuitry 140, to the “closed” position in which power is transmitted from the power source 15 to the circuitry 140. Accordingly, in the exemplary embodiment, the relay 112 is a “normally-closed” relay that is configured to transition from the closed position to the open position when the coil 122 is energized and then to transition back to the closed position when the relay 112 is de-energized.

During operation, it is desirable to enable a remote operator, such as a utility company for example, to operate the energy consuming device 2. In this manner, the utility company may enable the energy consuming device 2 to be activated during off-peak electrical consumption hours. Moreover, the utility company may disable the energy consuming device 2 during peak electrical consumption hours. Thus, the utility company may reduce the demand on the electrical grid during peak consumption hours while enabling energy consuming device 2 to operate during non-peak consumption hours.

As discussed above, the relay 112 physically enables power to be transmitted from the power source 15 to energy consuming device 2. Moreover, the relay 112 also physically inhibits power from being transmitted from the power source 15 to energy consuming device 2. In the exemplary embodiment, the relay 112 is controlled and operated by the communication module 10.

For example, in the first operational mode, when the utility desires to deactivate the energy consuming device 2, and thus reduce electrical consumption during peak usage hours, the utility company transmits a signal from the utility company (U) shown in FIG. 1. The signal (S) is received by the transceiver 132. In response to the received signal (S), the transceiver 132 transmits a signal S2 to a switch 136. In the exemplary embodiment, the switch 136 is a two-position switch that is either positioned in the “ON” configuration or the “OFF” configuration. The switch 136 may be a MOSFET for example. When the switch 136 is activated by the transceiver 132, the switch is positioned in the “ON” position. In the “ON” position, power is transmitted from the power source 15 through the coil 122 to generate an electromagnetic field in the coil 122. The electromagnetic field causes the switch 120 to move from a “closed” position, in which power is transmitted from the power source 15 to the circuitry 140, to an “open” position in which power is not transmitted from the power source 15 to the circuitry 140.

Optionally, when the utility company desires to reactivate or re-energize energy consuming device 2, and thus enable the energy consuming device 2 to be operated during off-peak usage hours, the utility company transmits a signal from the utility company (U) shown in FIG. 1. The signal (S) is received by the transceiver 132. In response to the received signal (S), the transceiver 132 transmits a signal S2 to the switch 136 to reposition the switch 134 in the “OFF” position. In the “OFF” position, power is not transmitted from the power source 15 through the coil 122 to generate an electromagnetic field in the coil 122. Thus, the switch 120, which is a normally-closed switch, moves from the “open” position in which power is not transmitted from the power source 15 to the circuitry 140, to the “closed” position in which power is transmitted from the power source 15 to the circuitry 140. It should be realized that because the switch 120 is a normally-closed switch, the switch 120 may be repositioned from the “open” position to the “closed” position by merely placing the switch 134 in the OFF position. More specifically, while one embodiment, describes transmitting a signal from the utility company to the transceiver 132 to “close” the switch 120, in another embodiment, the switch 120 may be placed in the “close” position by ceasing the transmission of the signal from the utility company to the transceiver 132.

In a third operational mode, the communication assembly 6 includes an override switch 138 that enables a local operator or homeowner to reactivate the energy consuming device 2 when the utility company has transmitted a signal to deactivate the energy consuming device 2, and thus reduce electrical consumption during peak usage hours. In the exemplary embodiment, the switch 138 is a push-button switch, or some equivalent electrical switch, that is located on the exterior of the energy consuming device 2. During operation, when the utility company has previously transmitted a signal to deactivate the energy consuming device 2, as described above, the local operator or homeowner may activate the switch 138 to override the commands transmitted by the utility company and received by the communication assembly 6 at the transceiver 132. In the exemplary embodiment, the communication assembly 6 may transmit a signal to the utility company or to the local operator providing a visual or audible indication that the utility company commands have been overridden by the local operator.

Of course, according to other specific embodiments, the communication signal may be sent from the utility company over the power lines, such as described for FIG. 7, the communication signals are tapped-off from the AC of the external power source 15 and sent to communication module 10 via the DC power/relay control wire connection shown in FIG. 8. According to various embodiments, the communication signals sent by the utility company regulate the discretionary functions of the power consuming device.

Described herein is an exemplary communication assembly for controlling the operation of a power consuming device, such as a home appliance. The communication assembly may be integrated with the power consuming device and provides an efficient method for connecting a utility company to the power consuming device. The communication assembly is easily installed to enable a manufacturer of the power consuming device to modify the conventional appliance to be demand-response-ready at a relatively low-cost. Moreover, the communication assembly may be retrofitted to a conventional appliance at any time. For example, the interface device 8 and the control module 13 may be installed at the factory, whereas the communication module 10 may be installed at a later time. Installing the communication module at a later time enables the remote operator to utilize a communication module that includes the most recent operational software based on the current KW usage criteria. Moreover, if the KW usage criteria changes after the communication module is installed, the remote user may either install an updated communication module, or reprogram the currently installed communication module by downloading updated software via the wireless transceiver.

More specifically, an electrical relay 112, an AC-DC converter 110, and a DC-DC converter 130 may be installed in the conventional appliance at the factory. The communication module 10 may then be installed at the owner's residence, etc. During operation, when a signal is transmitted from the remote source or utility company, the communication module 10 activates a MOSFET switch 136. The MOSFET enables a relatively high current flow to the coil 122 to open the relay switch 120, which in turn deactivates the appliance by disconnecting the AC power source 15 from the appliance circuitry 140. Moreover, the AC-DC converter 110 also supplies power to the communication module 10 even when the electrical relay's switch 120 is in the open position to enable remote signals to be received and acted upon by the communication module 10.

While this invention has been described as having an exemplary design, the present invention may be further modified within the spirit and scope of this disclosure. The application is, therefore, intended to cover any variations, uses, or adaptations of the invention using its general principles. Further, this application is intended to cover such departures from the present disclosure as come within known or customary practice in the art to which this invention pertains.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A power consuming device including control circuitry for normal operation of a plurality of components installed in said power consuming device, said power consuming device comprising:
a communication module, the communication module receiving communication signals from a remote source;
an electrical relay coupled between an external power source and the control circuitry, the electrical relay also coupled between the external power source and the communication module, the electrical relay coupling power from the external power source to the communication module, and wherein the electrical relay is configured to transmit power from the external power source to the control circuitry when the communication module energizes the electrical relay based on the communication signals.

2. The power consuming device of claim 1 wherein the power consuming device comprises a home appliance.

3. The power consuming device of claim 1 wherein the communication signals comprise wireless signals.

4. The power consuming device of claim 1 wherein the power consuming device is electrically coupled via the external power source to a power grid, the communication module operating the electrical relay based on the KW hours being consumed by the power grid.

5. The power consuming device of claim 1 further comprising a switch coupled between the electrical relay and the communication module, the communication module activating the switch to energize the electrical relay.

6. The power consuming device of claim 1, wherein the communication signals comprise wireless signals from a utility company, and to regulate the discretionary functions of the power consuming device based on the wireless signals.

7. The power consuming device of claim 1 further comprising an AC-DC converter coupled between the external power source and the electrical relay, the AC-DC converter configured to receive a first voltage from the external power source and output a second lower voltage to the electrical relay.

8. The power consuming device of claim 7 further comprising a DC-DC converter coupled between the AC-DC converter and the communication module, the DC-DC converter configured to receive a first voltage from the AC-DC converter and output a second lower voltage to the communication module.

9. The power consuming device of claim 1, further comprising a communication interface positioned on or adjacent to the power consuming device, the communication module configured to be inserted into the communication interface.

10. The power consuming device of claim 9, wherein the communication interface is a standardized port.

11. A communication assembly for interfacing with a public utility company and controlling discretionary functions of a power consuming device having control circuitry controlling a plurality of components installed in the power consuming device, the communication assembly comprising:
a communication module, the communication module receiving communication signals from a public utility;
a control module comprising an electrical relay coupled between an external power source and the control circuitry, the control module also coupled between the external power source and the communication module to provide power from the external power source to the communication module, and wherein the electrical relay is configured to transmit power from the external power source to the control circuitry when the communication module energizes the electrical relay based on the communication signals.

12. The communication assembly of claim 11 wherein the power consuming device comprises a home appliance.

13. The communication assembly of claim 11 wherein the communication signals comprise wireless signals.

14. The communication assembly of claim 11 wherein the power consuming device is configured to be electrically coupled via the external power source to a power grid, the public utility operating the relay based on the KW hours being consumed by the power grid.

15. The communication assembly of claim 11 further comprising a switch coupled between the electrical relay and the communication module, the communication module activating the switch to energize the electrical relay.

16. The communication assembly of claim 11, wherein the communication signals comprise wireless signals from a utility company, and said communication module is configured to regulate the discretionary functions of the power consuming device based on the wireless signals.

17. The communication assembly of claim 11 further comprising an AC-DC converter coupled between the external power source and the relay, the AC-DC converter configured to receive a first voltage from the external power source and output a second lower voltage to the electrical relay.

18. The communication assembly of claim 17 further comprising a DC-DC converter coupled between the AC-DC converter and the communication module, the DC-DC converter configured to receive a first voltage from the AC-DC converter and output a second lower voltage to the communication module.

19. The communication assembly of claim 11, further comprising a communication interface positioned on or adjacent to the power consuming device, the communication module configured to be inserted into the communication interface.

20. The communication assembly of claim 19, wherein the communication interface is a standardized port.

21. The communication assembly of claim 11, wherein the communication signals comprise power line communication signals tapped-off from an alternating current (AC) from the external power source and sent to the communication assembly via the direct current (DC) power/relay control wire connection.

22. The communication assembly of claim 11, wherein the communication signals comprise power line communication signals from a utility company, and said communication module is configured to regulate the discretionary functions of the power consuming device based on the power line communication signals.
